(19) United States
(12) Patent Application Publication
(10) Pub. No.: US 2024/0405491 A1
(43) Pub. Date: Dec. 5, 2024

(54) CONNECTOR

(71) Applicant: SUMITOMO WIRING SYSTEMS, LTD., Mie (JP)

(72) Inventor: Shuhei YAMADA, Mie (JP)

(21) Appl. No.: 18/668,704

(22) Filed: May 20, 2024

(30) Foreign Application Priority Data
May 29, 2023 (JP) 2023-087429

(51) Int. Cl. H01R 24/50; H01R 13/502; H01R 103/00

(52) U.S. Cl. CPC H01R 24/50; H01R 13/502; H01R 2103/00

(57) ABSTRACT

A housing includes a back wall portion and a tubular peripheral wall portion projecting forward from the back wall portion. A second outer conductor includes a tube portion to be passed through an insertion hole of the back wall portion and arranged inside the peripheral wall portion and a base portion to be arranged behind the back wall portion. The first outer conductor includes a bottom portion to be arranged behind the back wall portion to face the base portion. The bottom portion includes a through hole, through which an end part of a dielectric is passed. Mounting portions, to be electrically connected to a circuit board and positioning portions positionable on the circuit board includes project around the through hole in a bottom surface of the bottom portion.

### CROSS-REFERENCE TO RELATED APPLICATIONS

This application is based on and claims priority from Japanese Patent Application No. 2023-087429, filed on May 29, 2023, with the Japan Patent Office, the disclosure of which is incorporated herein in its entirety by reference.

### TECHNICAL FIELD

The present disclosure relates to a connector.

### BACKGROUND

A connector disclosed in Japanese Patent Laid-open Publication No. 2023-021590 is provided with an electrically conductive inner conductor, an electrically conductive first outer conductor called a coupling member, an electrically conductive second outer conductor called an outer conductor, and an insulating housing. The first outer conductor includes a bottom portion. Projecting end parts to be mounted on a circuit board project on a bottom surface of the bottom portion. The projecting end parts function as mounting portions to be mounted on the circuit board (hereinafter, referred to as mounting portions). The second outer conductor includes a tube portion called a connecting tube portion and a surrounding portion connected behind the tube portion. The surrounding portion is gate-shaped in a back view and includes left and right side walls and pairs of front and rear leg portions projecting down from the lower ends of the left and right side walls. The leg portions are positioned and inserted into positioning holes of the circuit board. Japanese Patent Laid-open Publication No. 2019-071272 discloses a connector provided with a plug body to be connected to a circuit board.

### SUMMARY

In the case of Japanese Patent Laid-open Publication No. 2023-021590, position shifts of the mounting portions with respect to the circuit board can be restricted by the leg portions. However, the leg portions and the mounting portions are respectively provided on the separate first and second outer conductors. To accurately restrict position shifts of the mounting portions with respect to the circuit board, the assembly accuracy of the first and second outer conductors needs to be enhanced, which may be accompanied by manufacturing difficulty.

Accordingly, the present disclosure aims to provide a connector capable of accurately restricting a position shift of a mounting portion with respect to a board.

The present disclosure is directed to a connector with an insulating housing, an electrically conductive outer conductor to be held in the housing, an electrically conductive inner conductor to be surrounded by the outer conductor, and an insulating dielectric to be interposed between the outer conductor and the inner conductor, the housing including a wall-like back wall portion in a direction intersecting a front-rear direction and a tubular peripheral wall portion projecting forward from the back wall portion, the back wall portion including an insertion hole, the outer conductor including a first outer conductor and a second outer conductor separate from each other, the second outer conductor including a tube portion to be passed through the insertion hole and arranged inside the peripheral wall portion and a base portion to be arranged behind the back wall portion, the base portion including a through bore communicating with inside of the tube portion, the dielectric being inserted into the through bore, the first outer conductor including a bottom portion to be arranged behind the back wall portion to face the base portion, the bottom portion including a through hole, an end part of the dielectric being fit through the through hole, and a mounting portion to be electrically connected to the circuit board and a positioning portion positionable on the circuit board being provided to project around the through hole in a bottom surface of the bottom portion.

According to the present disclosure, it is possible to provide a connector capable of accurately restricting a position shift of a mounting portion with respect to a circuit board.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a section of a connector of one embodiment.

FIG. 2 is a front view of the connector of the embodiment.

FIG. 3 is an exploded perspective view of a dielectric and an inner conductor in the connector of the embodiment.

FIG. 4 is a perspective view of a second outer conductor in the connector of the embodiment.

FIG. 5 is a perspective view of a first outer conductor in the connector of the embodiment.

FIG. 6 is an exploded perspective view of a housing and the second outer conductor in the connector of the embodiment.

FIG. 7 is an exploded perspective view of a module including the inner conductor, the dielectric, the second outer conductor and the housing and the first outer conductor in the connector of the embodiment.

FIG. 8 is a perspective view of the connector of the embodiment.

FIG. 9 is a bottom view enlargedly showing a part including the first outer conductor in the connector of the embodiment.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### DESCRIPTION OF EMBODIMENTS OF PRESENT DISCLOSURE

First, embodiments of the present disclosure are listed and described.

(1) The connector of the present disclosure is provided with an insulating housing, an electrically conductive outer conductor to be held in the housing, an electrically conductive inner conductor to be surrounded by the outer conductor, and an insulating dielectric to be interposed between the outer conductor and the inner conductor, the housing including a wall-like back wall portion in a direction intersecting a front-rear direction and a tubular peripheral wall portion projecting forward from the back wall portion, the back wall portion including an insertion hole, the outer conductor including a first outer conductor and a second outer conductor separate from each other, the second outer conductor including a tube portion to be passed through the insertion hole and arranged inside the peripheral wall portion and a base portion to be arranged behind the back wall portion, the base portion including a through bore communicating with inside of the tube portion, the dielectric being inserted into the through bore, the first outer conductor including a bottom portion to be arranged behind the back wall portion to face the base portion, the bottom portion including a through hole, an end part of the dielectric being fit through the through hole, and a mounting portion to be electrically connected to the circuit board and a positioning portion positionable on the circuit board being provided to project around the through hole in a bottom surface of the bottom portion.

Since the positioning portion and the mounting portion are provided to project on the bottom surface of the common first outer conductor, a position shift of the mounting portion with respect to the circuit board can be accurately restricted by the positioning portion.

(2) Preferably, in the connector of (1) described above, a contact surface for contacting a rear surface of the back wall portion is provided on a front surface of the base portion, and a restricting portion for restricting posture of the dielectric is provided in an inner surface of the through bore of the base portion.

Since the base portion has both a function of positioning the second outer conductor with respect to the housing and a function of restricting the posture of the dielectric with respect to the second outer conductor, the configuration of the outer conductor can be simplified.

(3) Preferably, in the connector of (1) or (2) described above, the first outer conductor includes a pair of side portions rising from the bottom portion, and the base portion is arranged to be sandwiched between the pair of side portions.

In the configuration of (3) described above, the base portion can be arranged between the pair of side portions with movements restricted.

(4) Preferably, in the connector of (3) described above, the pair of side portions include locking portions extending in a rising direction from the bottom portion and lockable to the housing by contacting the housing in the rising direction.

The first outer conductor is held in the housing by locking the locking portions to the housing. Particularly, since the locking portions can be shaped to extend long in the rising direction of the side portions in the configuration of (4) described above, sufficient locking margins of the locking portions and the housing can be ensured.

(5) Preferably, in the connector of (3) or (4) described above, the first outer conductor includes a back portion rising from the bottom portion and coupled to the pair of side portions, and the back portion is arranged behind the base portion to face the base portion.

A position shift of the second outer conductor in a direction retreating from the housing can be restricted by the contact of the back portion with the base portion.

(6) Preferably, in the connector of any one of (1) to (5) described above, the first outer conductor includes a pair of side portions rising from the bottom portion and a back portion rising from the bottom portion and coupled to the pair of side portions, and the base portion is fit and arranged in an inner space surrounded by the pair of side portions, the back portion and the bottom portion.

In the configuration of (6) described above, the base portion can be positioned and arranged in the inner space of the first outer conductor.

### DETAILS OF EMBODIMENT OF PRESENT DISCLOSURE

A specific example of the present disclosure is described below with reference to the drawings. Note that the present invention is not limited to this illustration, but is represented by claims and intended to include all changes in the scope of claims and in the meaning and scope of equivalents.

### EMBODIMENT

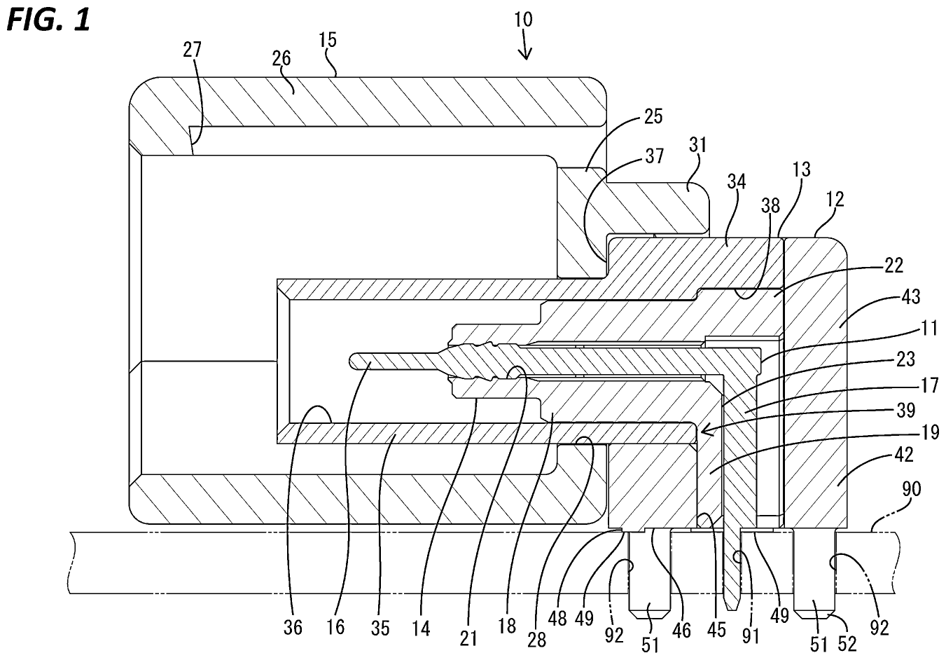

A connector 10 according to an embodiment is, as shown in FIG. 1, provided with an inner conductor 11, an outer conductor 12, 13, a dielectric 14 and a housing 15 and illustrated to be a board shield connector to be mounted on a circuit board 90. The housing 15 is connectable to an unillustrated mating connector. The inner conductor 11 and the outer conductor 12, 13 are made of electrically conductive metal. The dielectric 14 and the housing 15 are made of insulating resin. Note that, in the following description, a side where the mating connector is connected to the housing 15 is referred as a front side concerning a front-rear direction. A side where the connector 10 is mounted on the circuit board 90 is referred to as an upper side concerning a vertical direction. These directions are for convenience and do not necessarily coincide with direction references in a state where the connector 10 is installed in a vehicle or the like.

### (Inner Conductor and Dielectric)

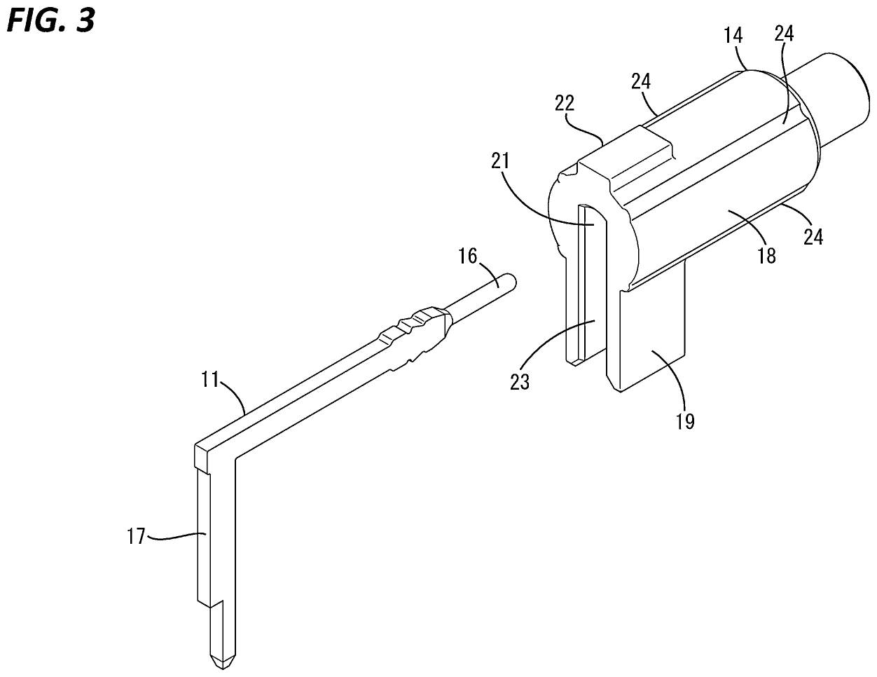

The inner conductor 11 is integrally formed, such as by bending, after a metal plate material is stamped. As shown in FIGS. 1 and 3, the inner conductor 11 is L-shaped in a side view and includes a mating connecting portion 16 extending in the front-rear direction and a board connecting portion 17 projecting downward from a rear end part of the mating connecting portion 16. The dielectric 14 is L-shaped in a side view and includes an accommodating portion 18 extending in the front-rear direction and a draw-out portion 19 projecting downward from a rear end part of the accommodating portion 18. The accommodating portion 18 includes a holding hole 21 extending in the front-rear direction. The mating connecting portion 16 is inserted and accommodated into the holding hole 21 from behind. A front end part of the mating connecting portion 16 is arranged to project forward from the accommodating portion 18 and electrically connected to an unillustrated mating inner conductor.

As shown in FIG. 3, the dielectric 14 includes a flat restricted portion 22 projecting on the upper surface of the rear end part of the accommodating portion 18. As shown in FIG. 1, the restricted portion 22 is fit into a first restricting portion 38 of a second outer conductor 13 to be described later. As shown in FIG. 3, the draw-out portion 19 includes a draw-out groove 23 extending in the vertical direction and open in a rear surface. The upper end of the draw-out groove 23 communicates with the holding hole 21. As shown in FIG. 1, the board connecting portion 17 is arranged along the groove surface of the draw-out groove 23. A lower end part of the board connecting portion 17 projects downward from the draw-out portion 19 and is inserted into a through-hole 91 formed in the circuit board 90 and connected by soldering.

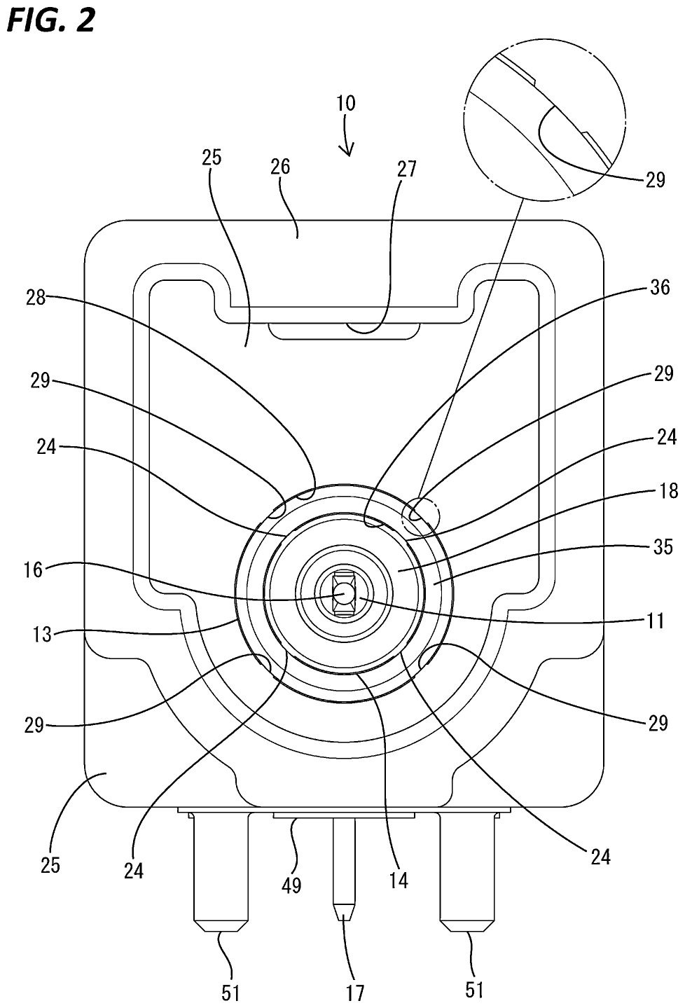

As shown in FIGS. 2 and 3, the dielectric 14 includes a plurality of assembly ribs 24 arranged at intervals in a circumferential direction on the outer peripheral surface of the accommodating portion 18. Each assembly rib 24 extends in the front-rear direction. The accommodating portion 18 of the dielectric 14 is inserted into a through bore 36 of the second outer conductor 13 to be described later. As shown in FIG. 2, each assembly rib 24 is squeezed into contact with the inner peripheral surface of the through bore 36, whereby the dielectric 14 is held in the second outer conductor 13.

### (Housing)

As shown in FIGS. 1, 2 and 6, the housing 15 has a tubular shape and includes a back wall portion 25 rectangular in front and back views and a tubular peripheral wall portion 26 projecting forward from the back wall portion 25.

The peripheral wall portion 26 includes a lock portion 27 projecting downward in a lateral central part of a front end side of an upper wall. The lock portion 27 is claw-like and locked to a mating lock portion provided on the unillustrated mating connector. The connector 10 and the mating connector are held in a connected state by the lock portion 27.

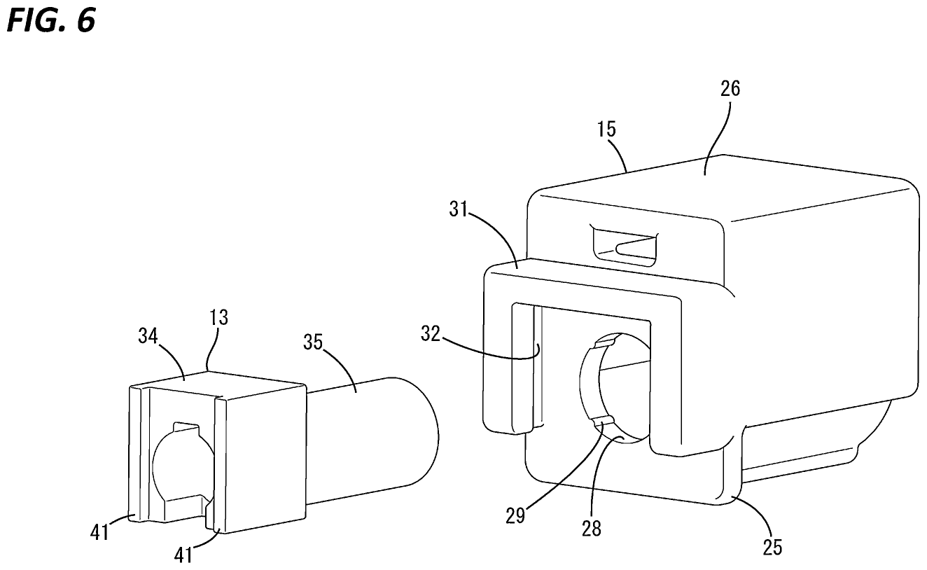

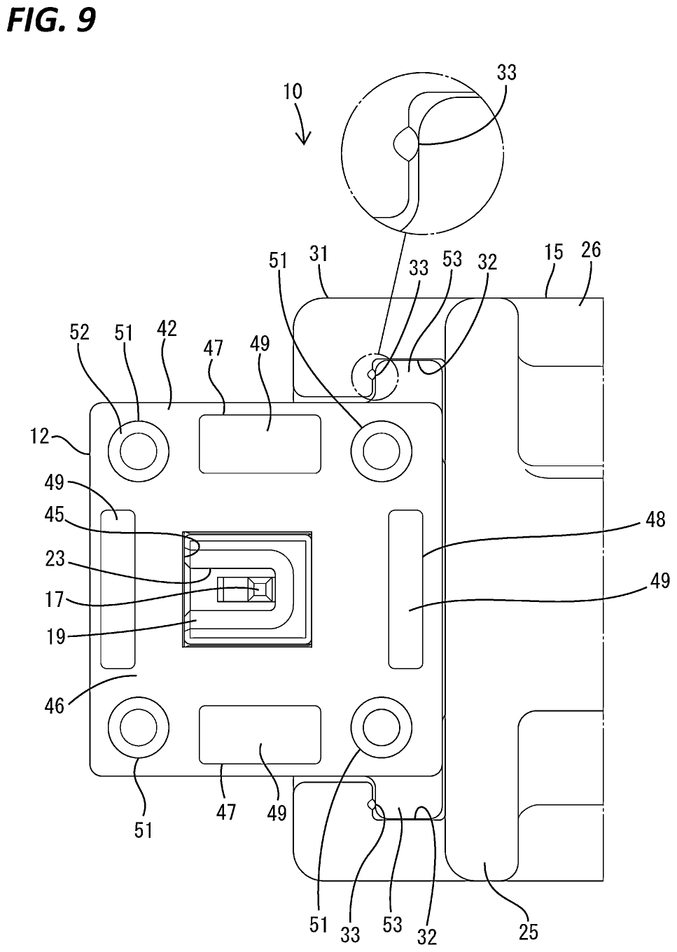

The back wall portion 25 is in the form of a wall along the vertical direction and a lateral direction (direction intersecting the front-rear direction). As shown in FIG. 1, the back wall portion 25 includes an insertion hole 28 extending in the front-rear direction and open in the front and rear surfaces of the back wall portion 25. As shown in FIGS. 2 and 6, the insertion hole 28 has a circular cross-section and includes a plurality of holding ribs 29 arranged at intervals in a circumferential direction on an inner surface. A tube portion 35 of the second outer conductor 13 to be described later is inserted into the insertion hole 28. The tube portion 35 is in contact with each holding rib 29 and held in the housing 15. As shown in FIG. 6, a rib-like frame portion 31 is provided to project on the rear surface of the back wall portion 25. The frame portion 31 is gate-shaped in a back view, and formed around an opening of the insertion hole 28 in the rear surface of the back wall portion 25. Further, as shown in FIG. 9, the frame portion 31 is formed with recesses 32 in inner surfaces (surfaces facing each other) of both left and right end parts. Each recess 32 extends in the vertical direction (see FIG. 6) and is open in the inner and lower surfaces of the frame portion 31. Each recess 32 includes a press-fit rib 33 extending in the vertical direction on an inner surface. The press-fit rib 33 can contact a locking portion 53 of the first outer conductor 12 to be described later while being squeezed.

### (Outer Conductor)

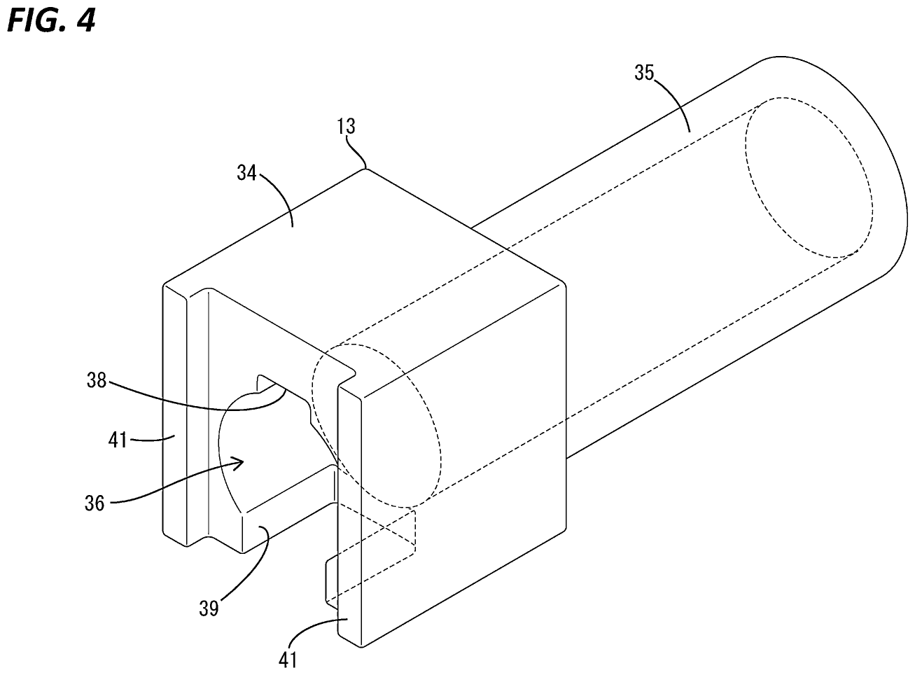

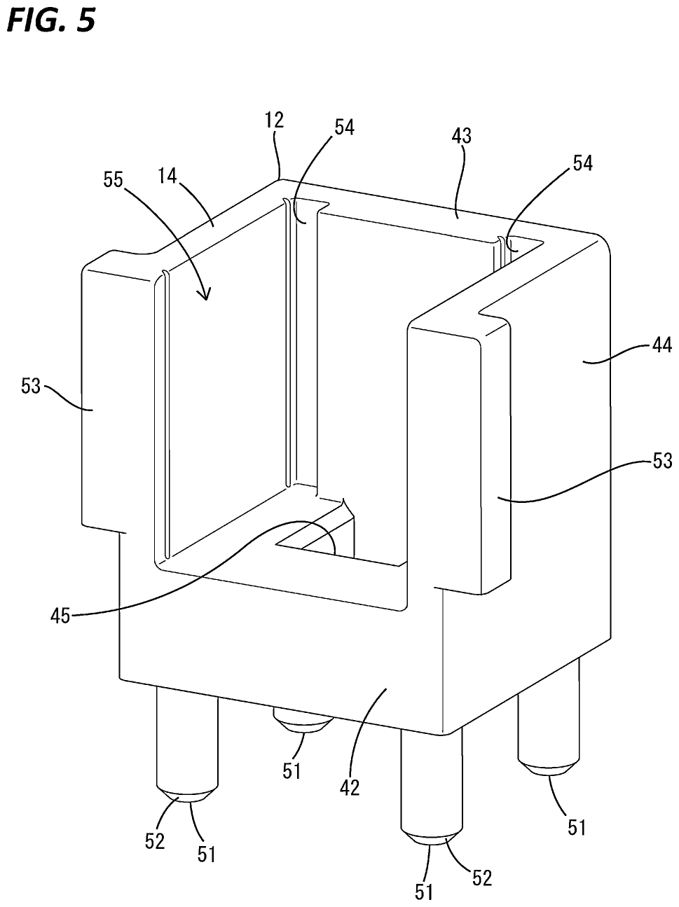

The outer conductor is composed of the first and second outer conductors 12, 13 separate from each other as shown in FIGS. 4 and 5. The first and second outer conductors 12, 13 are, for example, formed by die-casting zinc, zinc alloy or the like and vertically assembled in contact with each other.

As shown in FIG. 1, the second outer conductor 13 includes a base portion 34 to be arranged behind the back wall portion 25, and the tube portion 35 projecting forward from the base portion 34 and to be arranged inside the peripheral wall portion 26. As shown in FIG. 4, the base portion 34 has a rectangular block-like outer shape and has front and rear surfaces, upper and lower surfaces and left and right side surfaces. The tube portion 35 has a hollow cylindrical shape and projects forward from the front surface of the base portion 34.

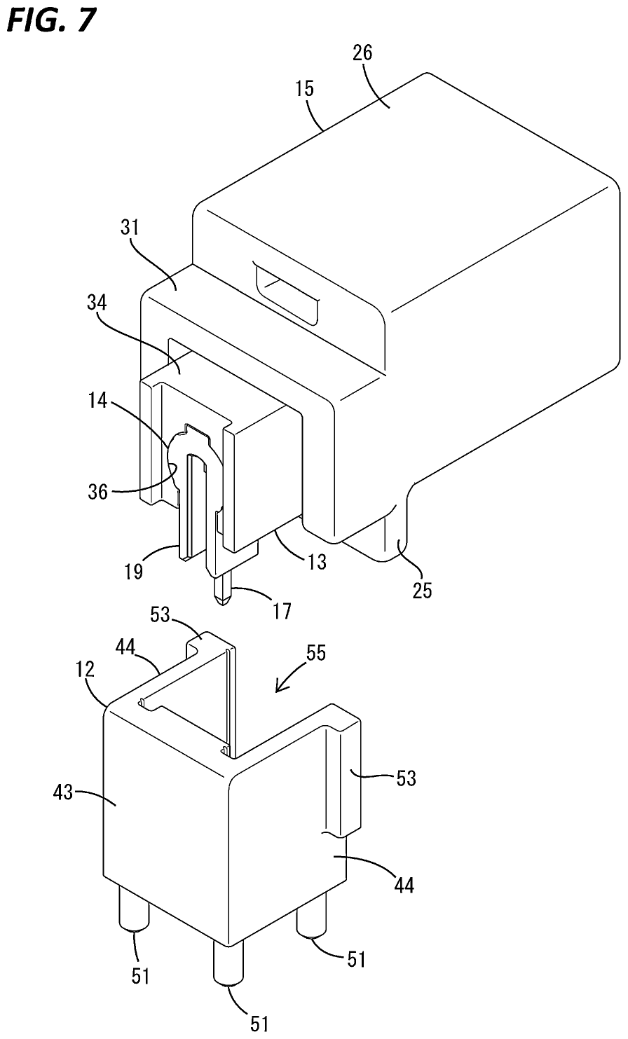

The second outer conductor 13 includes the through bore 36 continuously extending from the base portion 34 to the tube portion 35 and having a circular cross-section. The front end of the through bore 36 is open in the front surface of the tube portion 35 and open forward of the second outer conductor 13. The rear end of the through bore 36 is open in the rear surface of the base portion 34 and open rearward of the second outer conductor 13. The dielectric 14 is inserted into the through bore 36 from behind the base portion 34 (see FIGS. 1 and 7).

As shown in FIG. 1, the front surface of the base portion 34 has a vertical contact surface 37 along the vertical direction on the outer periphery of a coupled part to the tube portion 35. The tube portion 35 is inserted into the insertion hole 28 and the contact surface 37 faces and contacts the rear surface of the back wall portion 25, whereby the second outer conductor 13 is stopped in front in the housing 15.

The base portion 34 includes a restricting portion 38, 39 for restricting the posture of the dielectric 14 in the inner surface of the through bore 36. As shown in FIG. 4, the restricting portion includes the first restricting portion 38 formed by recessing the upper surface of the inner wall of the through bore 36 and a second restricting portion 39 penetrating through the lower surface of the inner wall of the through bore 36. The first restricting portion 38 extends in the front-rear direction while having a constant width in the upper surface of the inner wall of the through bore 36, and the rear end thereof is open in the rear surface of the base portion 34. The second restricting portion 39 likewise extends in the front-rear direction while having a constant width in the lower surface of the inner wall of the through bore 36, the rear end thereof is open in the rear surface of the base portion 34 and the lower end thereof is open in the lower surface of the base portion 34. As shown in FIG. 1, the restricted portion 22 is fit into the first restricting portion 38 and an upper end part of the draw-out portion 19 is fit into the second restricting portion 39, whereby an insertion posture of the dielectric 14 into the through bore 36 can be corrected. Further, the second outer conductor 13 includes rib-like fitting portions 41 extending in the vertical direction on both left and right end parts of the rear surface of the base portion 34.

As shown in FIG. 5, the first outer conductor 12 includes a bottom portion 42, a back portion 43 and a pair of side portions 44. The first outer conductor 12 is formed with an inner space 55 open upward and forward and surrounded by the bottom portion 42, the back portion 43 and the pair of side portions 44. The bottom portion 42 has a rectangular outer shape in a bottom view, and is formed to have a constant thickness in the vertical direction. The thickness of the bottom portion 42 is larger than that of each of the back portion 43 and the side portions 44. A through hole 45 having a rectangular cross-sectional shape is provided to penetrate through the bottom portion 42. As shown in FIG. 1, a lower end part of the draw-out portion 19 is fit into the through hole 45.

The bottom portion 42 has a bottom surface 46 arranged to face a surface of the circuit board 90. As shown in FIG. 9, the bottom surface 46 of the bottom portion 42 is flatly arranged along the lateral direction and front-rear direction. The bottom portion 42 is provided with a plurality of mounting portions 47, 48 arranged at intervals around an opening of the through hole 45 in the bottom surface 46. The respective mounting portions include lateral mounting portions 47 extending in the front-rear direction on lateral end parts of the bottom surface 46 and a front mounting portion 48 extending in the lateral direction in a front end part of the bottom surface 46. A width in the lateral direction of the lateral mounting portion 47 is larger than a width in the front-rear direction of the front mounting portion 48. Each mounting portion 47, 48 is in the form of a flat projection and has a flat mounting surface 49 extending along the lateral direction and front-rear direction on a lower end, which is a tip in a projecting direction. The mounting surface 49 of each mounting portion 47, 48 faces the surface of the circuit board 90 (see FIG. 1) and is connected to an unillustrated electrically conductive portion for grounding formed on the circuit board 90 by soldering. In this way, the first outer conductor 12 is electrically connected to the circuit board 90, and the second outer conductor 13 is also electrically connected to the circuit board 90 via the first outer conductor 12. The mounting surfaces 49 of the respective mounting portions 47, 48 are respectively so arranged as to be aligned at the same height position on the surface of the circuit board 90. Note that, in a case shown in FIG. 9, a flat mounting surface 49 extending in the lateral direction is also formed in a rear end part of the bottom surface 46.

The bottom portion 42 is provided with cylindrical positioning portions 51 respectively at four corner parts of the bottom surface 46. Each positioning portion 51 includes a tapered guiding portion 52 reduced in diameter on the outer peripheral surface of a tip side. The lateral mounting portion 47 is arranged between front and rear positioning portions 51. The front mounting portion 48 is arranged between the left and right positioning portions 51. As shown in FIG. 1, each positioning portion 51 is positioned and inserted into a corresponding positioning hole 92 formed in the circuit board 90. The guiding portion 52 guides an inserting operation of the positioning portion 51 into the positioning hole 92.

As shown in FIG. 5, the respective side portions 44 are shaped to rise from both left and right end parts of the upper surface (surface opposite to the bottom surface 46) of the bottom portion 42. The side portion 44 is in the form of a wall (plate) rectangular in a side view, and arranged with a wall surface (plate surface) facing in the lateral direction. In the front-rear direction, the front ends of each side portion 44 and the bottom portion 42 are arranged at the same position, and the rear ends of each side portion 44 and the bottom portion 42 are also arranged at the same position.

The first outer conductor 12 includes the locking portions 53 respectively protruding outward in the lateral direction from the front ends of the respective side portions 44. The locking portion 53 is in the form of a rib having a rectangular cross-sectional shape and extending in the vertical direction along the front end of the side portion 44, and the upper end thereof is flush with the upper end of the side portion 44. As shown in FIG. 9, the respective locking portions 53 are press-fit into the respective recesses 32, whereby the first outer conductor 12 is held in the housing 15.

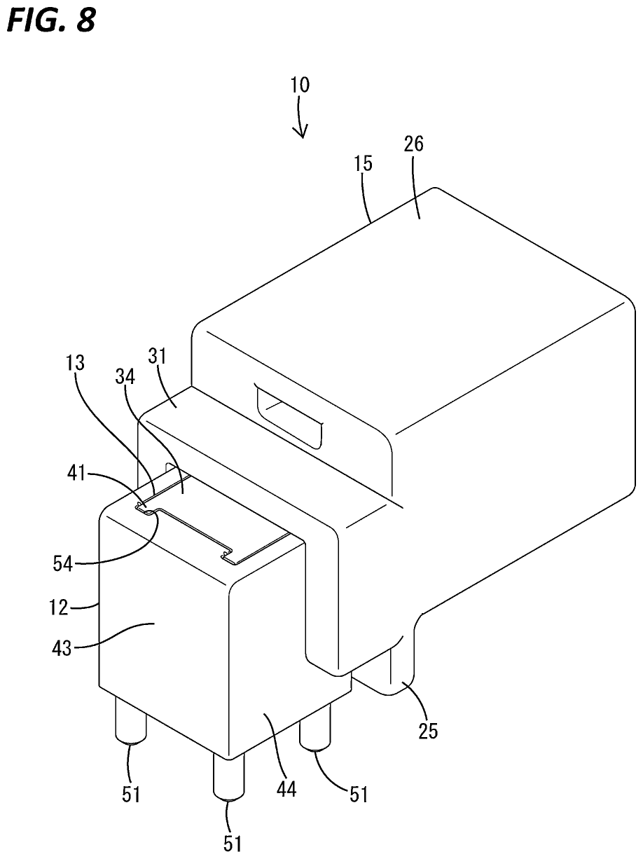

As shown in FIG. 5, the back portion 43 is shaped to rise from a rear end part of the upper surface of the bottom portion 42. The back portion 43 is in the form of a wall (plate) rectangular in a back view, and arranged with a wall surface (plate surface) facing in the front-rear direction. The back portion 43 is arranged between rear end parts of the respective side portions 44 and coupled to the respective side portions 44. The front surface of the back portion 43 is orthogonal to each of the inner surfaces (facing surfaces) of the respective side portions 44 and the upper surface of the bottom portion 42, and is connected to the rear surface of the inner wall of the through hole 45 without any step. The first outer conductor 12 includes recess-like receiving portions 54 extending in the vertical direction and open in the upper end of the back portion 43 on both left and right end parts of the front surface of the back portion 43. As shown in FIG. 8, the fitting portions 41 are fit into the receiving portions 54.

### (Functions)

In assembling the connector 10, the second outer conductor 13 is arranged behind the housing 15 and, in that state, the tube portion 35 is inserted into the insertion hole 28 as shown in FIG. 6. When the assembly of the second outer conductor 13 is completed, the contact surface 37 of the base portion 34 is stopped in contact with the rear surface of the back wall portion 25 (see FIG. 1). The tube portion 35 is passed through the insertion hole 28 and held in the back wall portion 25 by the respective holding ribs 29. A front part of the tube portion 35 is arranged to project into the inside of the peripheral wall portion 26. Subsequently, the accommodating portion 18 of the dielectric 14 is inserted into the through bore 36. The dielectric 14 is held in the second outer conductor 13 by the respective assembly ribs 24. The restricted portion 22 is fit into the first restricting portion 38 to specify the insertion posture of the dielectric 14 into the through bore 36. Further, before or after the assembly of the dielectric 14 with the second outer conductor 13, the mating connecting portion 16 of the inner conductor 11 is accommodated into the accommodating portion 18 of the dielectric 14. The front end part of the mating connecting portion 16 is arranged to project into the tube portion 35.

Subsequently, as shown in FIG. 7, the first outer conductor 12 is assembled with the second outer conductor 13 and the housing 15 from below. The base portion 34 of the second outer conductor 13 is fit into the inner space 55 of the first outer conductor 12 from above. The locking portions 53 of the respective side portions 44 are fit into the respective recesses 32 from below and contact the press-fit ribs 33, and the first outer conductor 12 is held in the housing 15 (see FIG. 9). The lower end part of the draw-out portion 19 is fit into the through hole 45 of the bottom portion 42, and a lower end part of the board connecting portion 17 is arranged to project further downward than the bottom surface 46 (see FIG. 1).

The respective fitting portions 41 of the base portion 34 are fit into the receiving portions 54 of the back portion 43 and the rear surface of the base portion 34 is arranged to be able to face and contact the front surface of the back portion 43 (see FIG. 8). In this way, the second outer conductor 13 is restricted from being positionally shifted in a direction retreating from the housing 15. The left and right side surfaces of the base portion 34 are arranged to be able to face and contact the inner surfaces of the respective side portions 44. The upper surface of the base portion 34 is arranged to be continuous and flush with the upper surface of each of the back portion 43 and the side portions 44. A rear part of the inner conductor 11 is surrounded by the first and second outer conductors 12, 13 via the dielectric 14, and electromagnetically shielded.

In the above way, the assembly of the connector 10 is completed. Thereafter, the connector 10 is placed on the surface of the circuit board 90. By inserting the respective positioning portions 51 into the respective positioning holes 92 of the circuit board 90, the connector 10 is positioned on the surface of the circuit board 90. The mounting surfaces 49 of the respective mounting portions 47, 48 are arranged to be able to contact the electrically conductive portions for grounding on the surface of the circuit board 90. A lower end part of the board connecting portion 17 is inserted into the through-hole 91 of the circuit board 90. In that state, soldering such as reflow soldering is applied, and the connector 10 is mounted on the circuit board 90.

In the case of this embodiment, the respective mounting portions 47, 48 are also provided on the bottom surface 46 of the bottom portion 42 provided with the respective positioning portions 51. When mounting portions and positioning portions are separately provided on first and second outer conductors unlike this embodiment, assembly tolerances of the first and second outer conductors need to be considered if an attempt is made to enhance the positioning accuracy of the respective mounting portions with respect to a circuit board. This is not easy in manufacturing. However, in the case of this embodiment, both the respective mounting portions 47, 48 and the respective positioning portions 51 are provided on the first outer conductor 12 and arranged on the same plane, i.e. on the bottom surface 46 as described above. Thus, assembly tolerances of the first and second outer conductors 12, 13 need not be considered, and position shifts of the respective mounting portions 47, 48 with respect to the circuit board 90 can be accurately restricted by the respective positioning portions 51.

Further, since the contact surface 37 for stopping the second outer conductor 13 in contact with the housing 15 and the restricting portion 38, 39 for restricting the insertion posture of the dielectric 14 into the through bore 36 are collectively provided on the base portion 34, the structure of the second outer conductor 13 can be simplified.

Further, since the base portion 34 is arranged to be sandwiched between the respective side portions 44, a position shift of the base portion 34 in the lateral direction can be restricted.

Further, since the locking portions 53 for holding the first outer conductor 12 in the housing 15 are shaped to extend long in the vertical direction, which is a rising direction of the side portions 44, sufficient locking margins of the locking portions 53 and the housing 15 can be ensured.

Further, since the back portion 43 is arranged behind the base portion 34 to face the base portion 34, a position shift of the second outer conductor 13 in the direction retreating from the housing 15 can be restricted.

Furthermore, since the base portion 34 can be fit and arranged in the inner space 55 surrounded by the respective side portions 44, the back portion 43 and the bottom portion 42 in the case of this embodiment, the base portion 34 can be positioned and arranged in the inner space 55 and shielding performance can be improved.

Furthermore, in the case of this embodiment, when the first outer conductor 12 is molded, a slide mold configured to slide in a direction intersecting the vertical direction can be made unnecessary by opening a mold in the vertical direction, which is a projecting direction of the respective positioning portions 51 and the respective mounting portions 47, 48. Further, when the second outer conductor 13 is molded, a slide mold configured to slide in a direction intersecting the front-rear direction can be made unnecessary by opening a mold in the front-rear direction, which is a formation direction of the through bore 36. Therefore, according to this embodiment, good moldability of the outer conductor 12, 13 can also be realized.

### OTHER EMBODIMENTS OF PRESENT DISCLOSURE

The embodiment disclosed this time should be considered illustrative in all aspects, rather than restrictive.

In the case of the above embodiment, one inner conductor 11 is provided and one dielectric 14 and one tube portion 35 are provided. In contrast, according to another embodiment, a plurality of inner conductors may be provided and a plurality of dielectrics and a plurality of tube portions may be provided. If a plurality of inner conductors are provided, a bottom portion may be formed with a plurality of through holes corresponding to the number of the inner conductors.

In the case of the above embodiment, the base portion 34 has a rectangular block-like outer shape as a whole. In contrast, according to another embodiment, a base portion may be shaped to include a ceiling wall portion in the form of a flat plate for closing the upper surface of an outer conductor.

In the case of the above embodiment, the restricting portion is composed of the first and second restricting portions 38, 39. In contrast, according to another embodiment, a restricting portion may be composed only of either one of first and second restricting portions. For example, if the restricting portion is composed only of the second restricting portion, a restricted portion may be omitted from a dielectric.

In the case of the above embodiment, the first outer conductor 12 is composed of the bottom portion 42, the back portion 43 and the pair of side portions 44. In contrast, according to another embodiment, a first outer conductor may be composed only of either a back portion or a pair of side portions. Further, one of the pair of side portions may be omitted from the first outer conductor.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector, comprising:
an insulating housing;
an electrically conductive outer conductor to be held in the housing;
an electrically conductive inner conductor to be surrounded by the outer conductor; and
an insulating dielectric to be interposed between the outer conductor and the inner conductor,
the housing including a wall-like back wall portion in a direction intersecting a front-rear direction and a tubular peripheral wall portion projecting forward from the back wall portion,
the back wall portion including an insertion hole,
the outer conductor including a first outer conductor and a second outer conductor separate from each other,
the second outer conductor including a tube portion to be passed through the insertion hole and arranged inside the peripheral wall portion and a base portion to be arranged behind the back wall portion,
the base portion including a through bore communicating with inside of the tube portion, the dielectric being inserted into the through bore,
the first outer conductor including a bottom portion to be arranged behind the back wall portion to face the base portion,
the bottom portion including a through hole, an end part of the dielectric being fit through the through hole, and
a mounting portion to be electrically connected to the circuit board and a positioning portion positionable on the circuit board being provided to project around the through hole in a bottom surface of the bottom portion.

2. The connector of claim 1, wherein:
a contact surface for contacting a rear surface of the back wall portion is provided on a front surface of the base portion, and
a restricting portion for restricting posture of the dielectric is provided in an inner surface of the through bore of the base portion.

3. The connector of claim 1, wherein:
the first outer conductor includes a pair of side portions rising from the bottom portion, and
the base portion is arranged to be sandwiched between the pair of side portions.

4. The connector of claim 3, wherein:
the pair of side portions include locking portions extending in a rising direction from the bottom portion and lockable to the housing by contacting the housing in the rising direction.

5. The connector of claim 3, wherein:
the first outer conductor includes a back portion rising from the bottom portion and coupled to the pair of side portions, and
the back portion is arranged behind the base portion to face the base portion.

6. The connector of claim 1, wherein:
the first outer conductor includes a pair of side portions rising from the bottom portion and a back portion rising from the bottom portion and coupled to the pair of side portions, and
the base portion is fit and arranged in an inner space surrounded by the pair of side portions, the back portion and the bottom portion.
